(19) United States
(12) Patent Application Publication
(10) Pub. No.: US 2015/0116524 A1
(43) Pub. Date: Apr. 30, 2015

(54) IMAGE CAPTURING APPARATUS, TERMINAL APPARATUS, CONTROL METHOD FOR THE SAME, AND SYSTEM

(71) Applicant: CANON KABUSHIKI KAISHA, Tokyo (JP)

(72) Inventors: Takashi Mizuno, Tokyo (JP); Takuma Mikawa, Yokohama-shi (JP)

(21) Appl. No.: 14/524,257

(22) Filed: Oct. 27, 2014

(30) Foreign Application Priority Data
Oct. 31, 2013 (JP) 2013-227534
Oct. 14, 2014 (JP) 2014-210170

(51) Int. Cl. H04N 5/232

(52) U.S. Cl. CPC H04N 5/23203
USPC 348/211.11

(57) ABSTRACT

A system in which an image capturing apparatus is externally operated by a terminal apparatus, the terminal apparatus comprises a unit which instructs the image capturing apparatus to start image capture processing, a unit which receives a first image acquired by the image capturing apparatus, a unit which acquires a second image by executing image capture processing for an object in response to the instruction, and a unit which records the first image and the second image in association with each other, and the image capturing apparatus comprises a unit which acquires the instruction for starting the image capture processing from the terminal apparatus, a unit which acquires the first image, and a unit which transmits the first image to the terminal apparatus.

### BACKGROUND OF THE INVENTION

1. Field of the Invention

The present invention relates to techniques for externally operating an image capturing apparatus to shoot an image.

2. Description of the Related Art

An image capturing apparatus, including a main camera that shoots an object side and a sub camera that shoots a photographer side, that simultaneously shoots an object with the main camera and the photographer with the sub camera is known (see Japanese Patent Laid-Open No. 2005-073161, for example). Using a terminal apparatus to remotely operate an image capturing apparatus and remotely shooting an object is also known (see Japanese Patent Laid-Open No. 2008-199460, for example).

When carrying out remote shooting using an image capturing apparatus that includes both a main camera and a sub camera in a single unit, as in Japanese Patent Laid-Open No. 2005-073161, the photographer cannot be shot using the sub camera.

Furthermore, although remote shooting is carried out in Japanese Patent Laid-Open No. 2008-199460 by operating the image capturing apparatus using the terminal apparatus, the document does not take shooting an object and the photographer simultaneously into consideration. In other words, the photographer cannot be shot using a sub camera of the terminal apparatus in the case where remote shooting is carried out using the image capturing apparatus.

### SUMMARY OF THE INVENTION

The present invention has been made in consideration of the aforementioned problems, and realizes a technique that can, when carrying out remote shooting by externally operating an image capturing apparatus, record an image shot by the image capturing apparatus and an image shot by a terminal apparatus in association with each other.

In order to solve the aforementioned problems, the present invention provides a system in which an image capturing apparatus is externally operated by a terminal apparatus to shoot an image, wherein the terminal apparatus comprises: an instructing unit configured to instruct the image capturing apparatus to start image capture processing; a receiving unit configured to receive a first image acquired by the image capturing apparatus receiving the instruction and executing the image capture processing; a sub capturing unit configured to acquire a second image by executing image capture processing for an object in response to an instruction from the instructing unit; and a recording unit configured to record the first image and the second image in association with each other, and wherein the image capturing apparatus comprises: an acquiring unit configured to acquire the instruction for starting the image capture processing from the terminal apparatus; a main capturing unit configured to acquire the first image by executing image capture processing for an object in response to the instruction; and a transmitting unit configured to transmit the first image to the terminal apparatus.

In order to solve the aforementioned problems, the present invention provides a terminal apparatus comprising: a communication unit configured to establish communication with an image capturing apparatus; an instructing unit configured to instruct the image capturing apparatus to start image capture processing; a receiving unit configured to receive a first image acquired by the image capturing apparatus receiving the instruction and executing the image capture processing; a sub capturing unit configured to acquire a second image by executing image capture processing for an object in response to an instruction from the instructing unit; and a recording unit configured to record the first image and the second image in association with each other.

In order to solve the aforementioned problems, the present invention provides an image capturing apparatus comprising: a main capturing unit configured to acquire a first image by executing image capture processing for a first object; a sub capturing unit configured to acquire a second image by executing image capture processing for a second object present in a different location than the first object; an acquiring unit configured to acquire an instruction for starting the image capture processing from a terminal apparatus; an accepting unit configured to directly accept an instruction to start the image capture processing in response to a photographer operating the image capturing apparatus; and a capturing control unit configured to carry out control so as to stop the execution of the image capture processing by the sub capturing unit, execute the image capture processing by the main capturing unit, and acquire the first image when the instruction has been acquired by the acquiring unit, and carry out control so as to execute the image capture processing by the main capturing unit and the sub capturing unit and acquire the first image and the second image when the instruction has been accepted by the accepting unit.

In order to solve the aforementioned problems, the present invention provides a system in which an image capturing apparatus is externally operated by a terminal apparatus to shoot an image, wherein the terminal apparatus comprises: an instructing unit configured to instruct the image capturing apparatus to start image capture processing; a sub capturing unit configured to acquire a second image by executing image capture processing for an object in response to an instruction from the instructing unit; and a transmitting unit configured to transmit the second image to the image capturing apparatus, and wherein the image capturing apparatus comprises: an acquiring unit configured to acquire the instruction for starting the image capture processing from the terminal apparatus; a main capturing unit configured to acquire a first image by executing image capture processing for an object in response to the instruction; a receiving unit configured to receive the second image from the terminal apparatus; and a recording unit configured to record the first image and the second image in association with each other.

In order to solve the aforementioned problems, the present invention provides a terminal apparatus comprising: a communication unit configured to establish communication with an image capturing apparatus; an instructing unit configured to instruct the image capturing apparatus to start image capture processing; a sub capturing unit configured to acquire a second image by executing image capture processing for an object in response to an instruction from the instructing unit; and a transmitting unit configured to transmit the second image to the image capturing apparatus, wherein the second image is recorded in association with a first image acquired by the image capturing apparatus executing image capture processing for an object in response to the instruction.

In order to solve the aforementioned problems, the present invention provides an image capturing apparatus comprising: a communication unit configured to establish communication with a terminal apparatus; an accepting unit configured to accept an instruction for starting image capture processing from the terminal apparatus; a main capturing unit configured to acquire a first image by executing the image capture processing for an object in response to the instruction; a receiving unit configured to receive, from the terminal apparatus, a second image acquired by a sub capturing unit of the terminal apparatus executing image capture processing for an object in response to the instruction; and a recording unit configured to record the first image and the second image in association with each other.

In order to solve the aforementioned problems, the present invention provides a system in which an image capturing apparatus is externally operated by a terminal apparatus to shoot an image, wherein the terminal apparatus comprises: an instructing unit configured to instruct the image capturing apparatus to start image capture processing; a sub capturing unit configured to acquire a second image by executing image capture processing for an object in response to an instruction from the instructing unit; and a first transmitting unit configured to transmit the second image to a server apparatus over a network, wherein the image capturing apparatus comprises: an acquiring unit configured to acquire the instruction for starting the image capture processing from the terminal apparatus; a main capturing unit configured to acquire the first image by executing image capture processing for an object in response to the instruction; and a second transmitting unit configured to transmit the first image to the server apparatus over a network, and wherein the server apparatus comprises: a recording unit configured to record the first image and the second image in association with each other.

In order to solve the aforementioned problems, the present invention provides a control method of a terminal apparatus which includes a capturing unit and externally operates an image capturing apparatus to shoot an image, the method comprising: a step of establishing communication with the image capturing apparatus; a step of instructing the image capturing apparatus to start image capture processing; a step of receiving a first image acquired by the image capturing apparatus receiving the instruction and executing the image capture processing; a step of acquiring a second image by executing the image capture processing for an object in response to the instruction; and a step of recording the first image and the second image in association with each other.

In order to solve the aforementioned problems, the present invention provides a control method of an image capturing apparatus, the method comprising: a step of acquiring a first image by executing image capture processing for a first object; a step of acquiring a second image by executing image capture processing for a second object present in a different location than the first object; a step of acquiring an instruction for starting the image capture processing from a terminal apparatus; a step of directly accepting an instruction to start the image capture processing in response to a photographer operating the image capturing apparatus; and a step of carrying out control so as to stop the execution of the image capture processing for acquiring the second image, execute the image capture processing for acquiring the first image, and acquire the first image when the instruction has been acquired from the terminal apparatus, and carrying out control so as to execute the image capture processing for acquiring the first image and the image capture processing for acquiring the second image and acquire the first image and the second image when the instruction has been directly accepted.

In order to solve the aforementioned problems, the present invention provides a control method of a terminal apparatus, the method comprising: a step of establishing communication with the image capturing apparatus; a step of instructing the image capturing apparatus to start image capture processing; a step of acquiring a second image by executing the image capture processing for an object in response to the instruction; and a step of transmitting the second image to the image capturing apparatus, wherein the second image is recorded in association with a first image acquired by the image capturing apparatus executing image capture processing for an object in response to the instruction.

In order to solve the aforementioned problems, the present invention provides a control method of an image capturing apparatus, the method comprising: a step of establishing communication with a terminal apparatus; a step of accepting an instruction for starting image capture processing from the terminal apparatus; a step of acquiring a first image by executing the image capture processing for an object in response to the instruction; a step of receiving, from the terminal apparatus, a second image acquired by the terminal apparatus executing image capture processing for an object in response to the instruction; and a step of recording the first image and the second image in association with each other.

According to the present invention, when carrying out shooting by externally operating an image capturing apparatus, an image shot by the image capturing apparatus and an image shot by a terminal apparatus can be recorded in association with each other.

Further features of the present invention will become apparent from the following description of an exemplary embodiment (with reference to the attached drawings).

### BRIEF DESCRIPTION OF THE DRAWINGS

FIGS. 1A and 1B are system configuration diagrams according to an embodiment of the present invention.

FIG. 2 is a block diagram illustrating the configuration of a terminal apparatus and an image capturing apparatus according to an embodiment of the present invention.

FIGS. 3A and 3B are flowcharts illustrating operations performed by the terminal apparatus and the image capturing apparatus according to an embodiment of the present invention.

FIGS. 4A to 4D are diagrams illustrating examples of display screens in the terminal apparatus and the image capturing apparatus according to an embodiment of the present invention.

FIGS. 5A and 5B are flowcharts illustrating operations performed in a remote shooting mode carried out by the terminal apparatus and the image capturing apparatus according to an embodiment of the present invention.

FIG. 6 is a diagram illustrating an example of a table in which main images shot by an image capturing apparatus are associated with sub images shot by a terminal apparatus.

FIG. 7 is a diagram illustrating an example of an image in which a main image shot by an image capturing apparatus is combined with a sub image shot by a terminal apparatus.

### DESCRIPTION OF THE EMBODIMENTS

Embodiments of the present invention will be described in detail below. The following embodiments are merely examples for practicing the present invention. The embodiments should be properly modified or changed depending on various conditions and the structure of an apparatus to which the present invention is applied. The present invention should not be limited to the following embodiments.

Hereinafter, a system in which a digital camera and a smartphone are employed as a terminal apparatus and an image capturing apparatus, respectively, according to the present invention, and remote shooting is carried out by using the terminal apparatus to remotely operate the image capturing apparatus, will be described. Although the present embodiment assumes a smartphone as a terminal apparatus 101, the embodiment can also be applied in a mobile electronic device such as a mobile telephone, a tablet terminal, or the like provided with the camera. An information processing apparatus such as a personal computer provided with a camera may be employed as well.

System Configuration

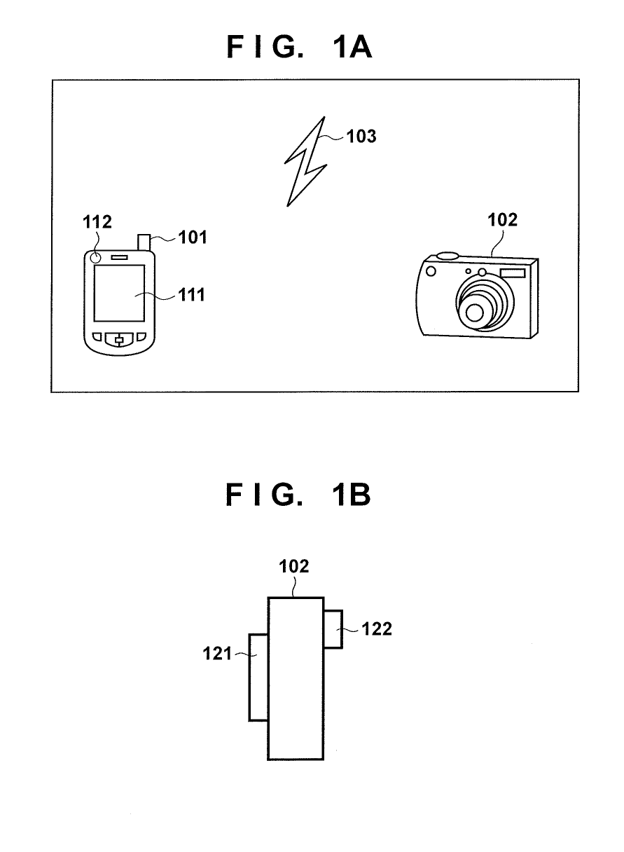

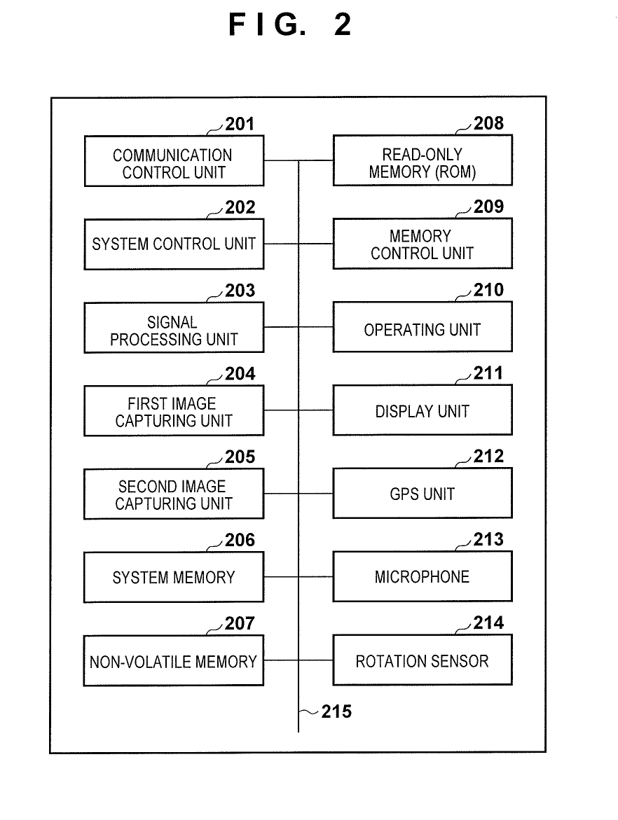

First, a system configuration according to the present embodiment will be described with reference to FIGS. 1A and 1B.

In the system according to the present embodiment, the terminal apparatus 101 and an image capturing apparatus 102 are communicably connected via a communication network 103 such as Wi-Fi, and the terminal apparatus 101 acts as a remote controller that controls shooting carried out by the image capturing apparatus 102. A photographer holds the terminal apparatus 101, and an image shot by the image capturing apparatus 102 is displayed in a display unit 111 of the terminal apparatus 101. Even if the photographer is away from the image capturing apparatus 102, he or she can confirm the image shot by the image capturing apparatus 102 by viewing a live-view image displayed in the display unit 111 of the terminal apparatus 101. The terminal apparatus 101 includes a sub camera 112 that shoots an image of the photographer who is operating the terminal apparatus 101. The terminal apparatus 101 transmits, to the image capturing apparatus 102, a shooting command that instructs shooting to start, and upon receiving the shooting command, the image capturing apparatus 102 executes a process for capturing an image of an object and acquires an image. The image capturing apparatus 102 transmits an image shot by a main camera 121 of the image capturing apparatus 102 to the terminal apparatus 101. Note that the image capturing apparatus 102 can also shoot an image by accepting an operation directly from the photographer without going through the terminal apparatus 101, and the image capturing apparatus 102 includes a main camera 121 that shoots an image on the object side and a sub camera 122 that shoots an image on the side where the photographer operating the image capturing apparatus 102 is present. The image capturing apparatus 102 can simultaneously shoot an image on the object side using the main camera 121 and an image on the photographer side using the sub camera 122. In other words, the main camera 121 and the sub camera 122 face different directions, and shoot objects that are present in respectively different locations.

Although a wireless LAN standard such as Wi-Fi is used as the communication network standard here, the standard may instead be wireless communication using Bluetooth® or the like, a third-generation mobile communication system (3G), a fourth-generation mobile communication system (4G), a wired communication standard, or the like. Meanwhile, it is assumed that a remote shooting application program (called a “shooting control app” hereinafter) is installed in the terminal apparatus 101.

The image capturing apparatus 102 is assumed to be capable of selecting between shooting in a normal shooting mode and shooting in a remote shooting mode. The “normal shooting mode” is a mode in which the image capturing apparatus 102 accepts an operation directly from the photographer and shoots an image. In the normal shooting mode, the image capturing apparatus 102 records image data shot using the main camera 121 (called “main image data” hereinafter) and image data shot using the sub camera 122 (called “sub image data” hereinafter) in association with each other. On the other hand, the “remote shooting mode” is a mode in which the terminal apparatus 101 is used to externally operate the image capturing apparatus 102 to shoot an image. In the remote shooting mode, the image capturing apparatus 102 transmits, to the terminal apparatus 101, image data shot using the main camera 121 of the image capturing apparatus 102 (also called “main image data” hereinafter). Then, the terminal apparatus 101 records the main image data received from the image capturing apparatus 102 and image data shot by the sub camera 112 of the terminal apparatus 101 (also called “sub image data” hereinafter) in association with each other. In the case where the terminal apparatus 101 displays the main image data and the sub image data recorded in association with each other, a sub image is superimposed and displayed upon a main image in a reduced state.

Apparatus Configuration

Configurations and functions of the terminal apparatus and the image capturing apparatus that configure the system according to the present embodiment will now be described with reference to FIG. 2.

The present embodiment describes a case in which the terminal apparatus 101 is realized by a communication device such as a smartphone, a tablet device, or the like and the image capturing apparatus 102 is realized by a digital camera, a digital video camera, or the like as an example. Note that the terminal apparatus 101 and the image capturing apparatus 102 have the same primary configuration with respect to the present invention, and thus the following descriptions of the configurations and functions for realizing the present invention will apply to both apparatuses.

Referring to FIG. 2, a communication control unit 201 has a function for communicating with a device aside from the terminal apparatus 101 or the image capturing apparatus 102, and controls communication with the terminal apparatus 101 or the image capturing apparatus 102 via a communication network such as Wi-Fi.

A system control unit 202 is a computational processing unit (a CPU, for example) that controls the terminal apparatus 101 or the image capturing apparatus 102 as a whole, and realizes the respective processes in the flowchart described later by executing programs stored in a read-only memory 208, which will be described later as well.

A signal processing unit 203 carries out signal processes such as compression/encoding, edge enhancement, noise removal, and so on on image data captured by a first image capturing unit 204, a second image capturing unit 205, and so on.

The first image capturing unit 204 configures the main camera that shoots the object side, and includes a lens group having a zoom lens, a focus lens, and the like, as well as a shutter provided with an aperture function. The first image capturing unit 204 also includes an image sensor configured of a CCD, a CMOS, or the like that converts an object image into an electrical signal, as well as an A/D converter that converts an analog image signal output from the image sensor into a digital signal. Note that the terminal apparatus 101 need not include the first image capturing unit 204 (main camera).

The second image capturing unit 205 configures the sub camera that shoots the photographer side, and has the same configuration as the first image capturing unit 204.

A system memory (primary storage unit) 206 is a DRAM or the like, and is also used as a work memory for loading constants, variables, and so on used in the operation of the system control unit 202, programs and the like read out from the read-only memory 208, and so on.

A non-volatile memory (secondary storage unit) 207 is configured of a flash memory, a hard disk, or the like and stores the shooting control app according to the present embodiment, various types of parameters, and so on.

The read-only memory 208 is a ROM or the like that stores programs executed by the system control unit 202.

A memory control unit 209 has a function for controlling access to an external storage medium such as a memory card connected via a USB interface or the like, and stores image data generated by the signal processing unit 203 processing an image shot by the main camera, the sub camera, or the like. A memory card, a hard disk drive, or the like serves as the external storage medium.

An operating unit 210 includes a touch panel, a cursor key, a set/execute button, a menu key, and so on, and the photographer can make various types of instructions to the terminal apparatus 101 or the image capturing apparatus 102 using the operating unit 210.

A display unit 211 is a display device, such as a liquid crystal panel or an organic EL panel, for displaying image data, GUI screens, or the like in the terminal apparatus 101 or the image capturing apparatus 102.

A GPS unit 212 includes a GPS antenna for acquiring current shooting position information of the terminal apparatus 101 or the image capturing apparatus 102.

A microphone 213 collects audio when shooting moving images in order to record audio information along with moving image data.

A rotation sensor 214 acquires rotation information with respect to six axes in order to detect tilting in the terminal apparatus 101 or the image capturing apparatus 102.

A bus 215 includes an address bus for the system control unit 202, a data bus, and a control bus.

Shooting Control App

Next, the remote shooting application (shooting control app) according to the present embodiment will be described.

The shooting control app according to the present embodiment is installed in the terminal apparatus 101, and is stored in the non-volatile memory 207. By launching the shooting control app and controlling the various units in accordance therewith, the system control unit 202 of the terminal apparatus 101 communicates with the image capturing apparatus 102 and controls shooting performed by the image capturing apparatus 102. Meanwhile, the shooting control app is provided with shooting modes such as the normal shooting mode, the remote shooting mode, and so on, and the terminal apparatus 101 can switch between and shoot in these modes. As a result of the terminal apparatus 101 and the image capturing apparatus 102 communicating with each other, the shooting command is transmitted from the terminal apparatus 101 to the image capturing apparatus 102, and the main image data shot by the main camera 121 of the image capturing apparatus 102 is transmitted from the image capturing apparatus 102 to the terminal apparatus 101.

Remote Shooting Process

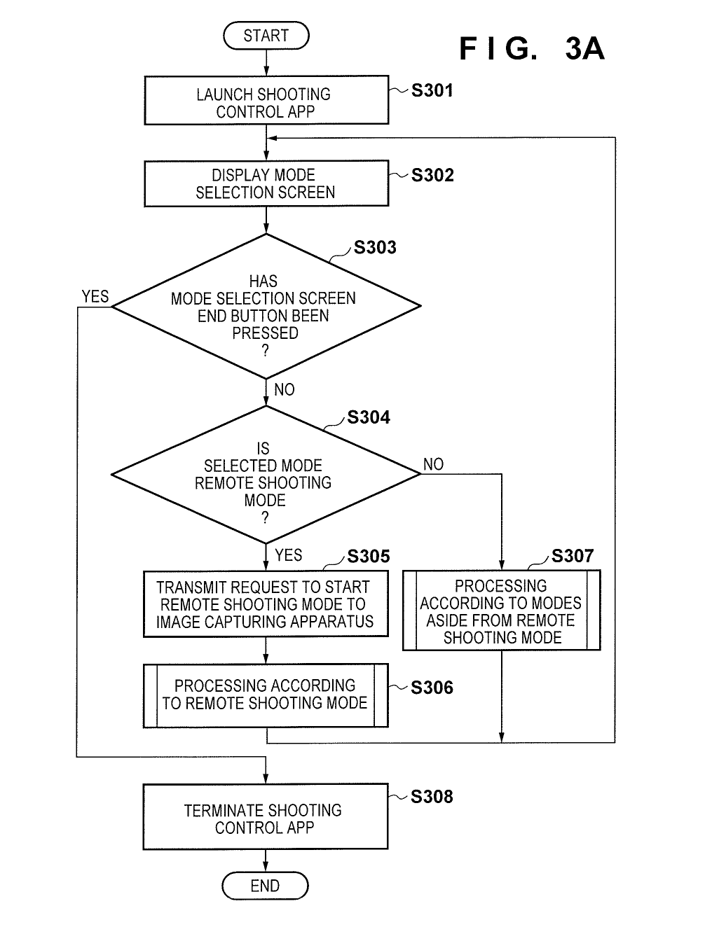

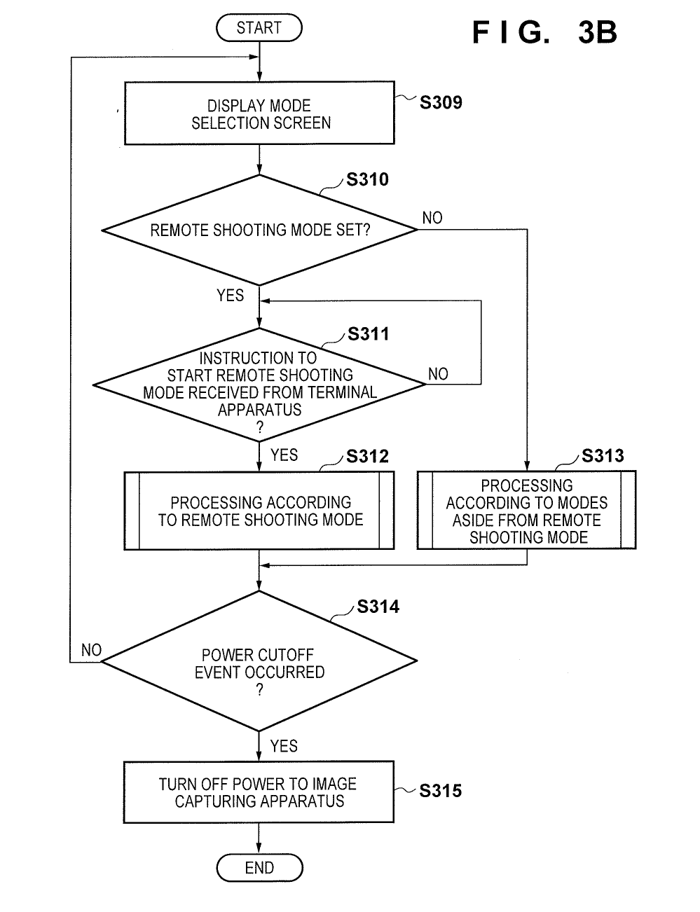

Next, a remote shooting process performed by the terminal apparatus 101 and the image capturing apparatus 102 according to the present embodiment will be described with reference to FIGS. 3A and 3B.

Note that FIG. 3A indicates processing performed by the terminal apparatus 101, whereas FIG. 3B indicates processing performed by the image capturing apparatus 102. The processing shown in FIGS. 3A and 3B is started when communication is established between the terminal apparatus 101 and the image capturing apparatus 102, the shooting control app stored in the non-volatile memory 207 is launched on the terminal apparatus side, and the remote shooting mode is set on the image capturing apparatus side. The processing in FIGS. 3A and 3B is realized by the system control unit 202 in both the terminal apparatus 101 and the image capturing apparatus 102 loading a remote shooting program stored in the non-volatile memory 207 into the system memory 206 and executing the program.

First, the processing performed by the terminal apparatus 101 will be described with reference to FIG. 3A. The processing described hereinafter is executed by the system control unit 202 of the terminal apparatus 101.

In step S301, the system control unit 202 launches the shooting control app.

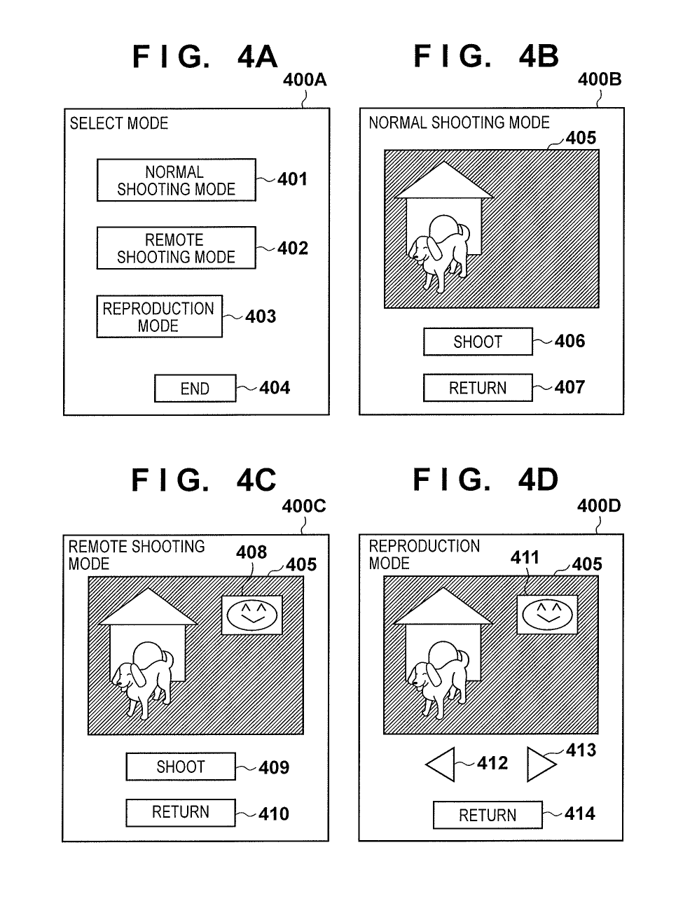

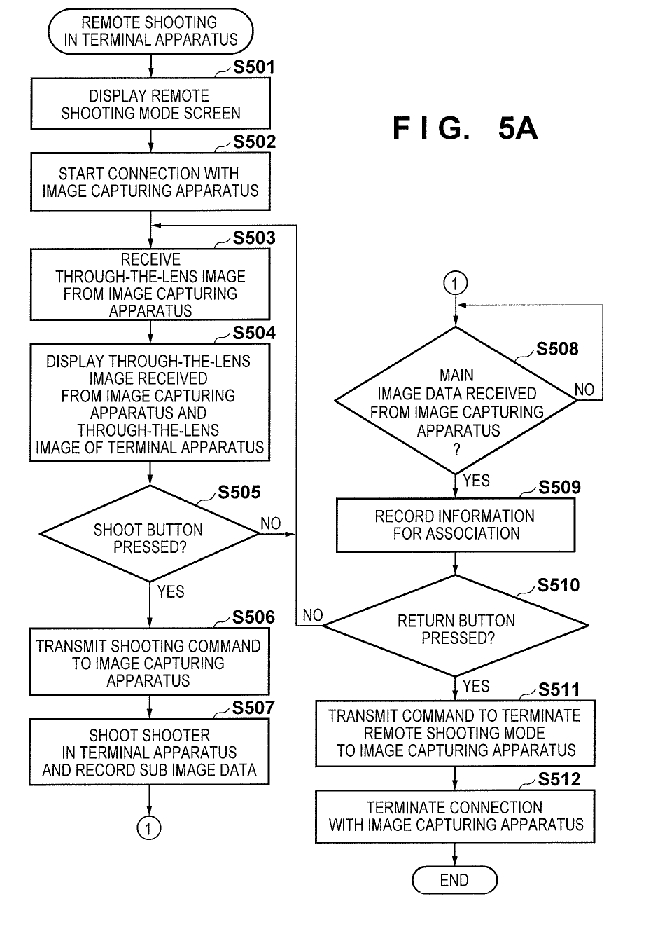

In step S302, the system control unit 202 displays a mode selection screen 400A, illustrated in FIG. 4A. Using this screen 400A, the photographer can select one of a plurality of modes, such as the normal shooting mode, the remote shooting mode, a reproduction mode, or the like.

In step S303, the system control unit 202 determines whether an end button in the mode selection screen 400A has been pressed. In the case where it is determined that the end button has not been pressed, the processing moves to step S304, whereas in the case where it is determined that the end button has been pressed, the processing moves to step S308.

In step S304, the system control unit 202 determines whether the selected mode is the remote shooting mode. In the case where it is determined that the mode is the remote shooting mode, the processing moves to step S305, whereas in the case where it is determined that the mode is not the remote shooting mode, or in other words, is the normal shooting mode or the reproduction mode, the processing moves to step S307.

In step S305, the system control unit 202 transmits, to the image capturing apparatus 102, a request to start the remote shooting mode.

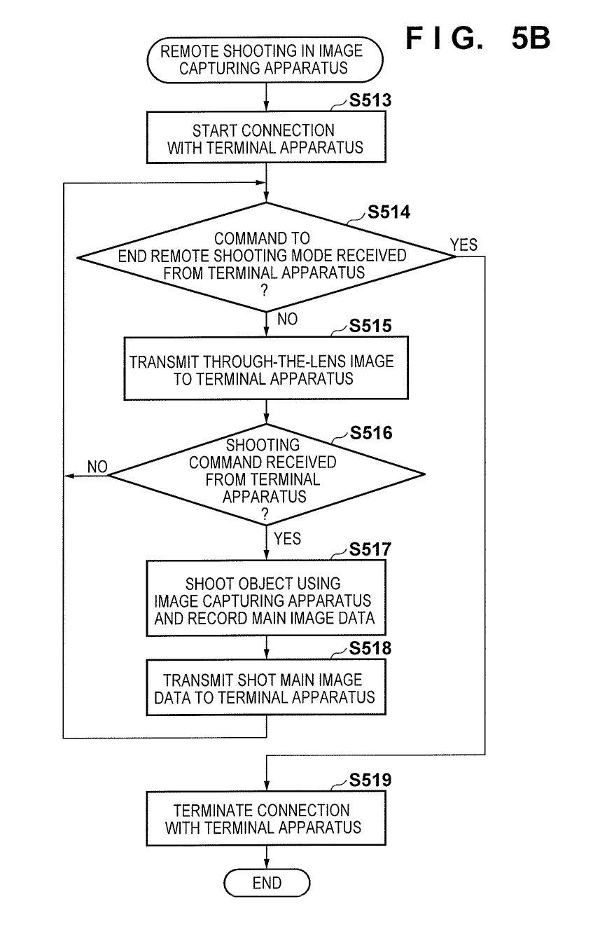

In step S306, the system control unit 202 carries out processing according to the remote shooting mode. Details of the processing performed in the remote shooting mode will be given later with reference to FIG. 5A.

In step S307, the system control unit 202 carries out processing aside from the remote shooting mode processing. In the case where the mode selected through the mode selection screen 400A is the normal shooting mode, processing according to the normal shooting mode is carried out, whereas in the case where the selected mode is the reproduction mode, processing according to the reproduction mode is carried out. During the normal shooting mode, a screen 400B such as that illustrated in FIG. 4B is displayed, where the main image or the sub image obtained through the image capture processing performed by the first image capturing unit 204 or the second image capturing unit 205 of the terminal apparatus 101 is displayed. A screen 400D such as that illustrated in FIG. 4D is displayed in the reproduction mode. In FIG. 4D, the main image obtained through the image capture processing performed by the first image capturing unit 204 of the image capturing apparatus 102 and the sub image obtained through the image capture processing performed by the second image capturing unit 205 of the terminal apparatus 101 or the image capturing apparatus 102 are displayed. In the case where a return button 407 or 414 is pressed during the normal shooting mode or the reproduction mode, the mode is terminated and the mode selection screen 400A illustrated in FIG. 4A is displayed again. Note that detailed descriptions of the processing performed in the normal shooting mode, the reproduction mode, and so on will be omitted here.

In step S308, the system control unit 202 terminates the shooting control app and ends the present processing.

Next, the processing performed by the image capturing apparatus 102 will be described with reference to FIG. 3B. The processing described hereinafter is executed by the system control unit 202 of the image capturing apparatus 102.

Note that the image capturing apparatus 102 can be set to one of the normal shooting mode, the remote shooting mode, and the reproduction mode. The normal shooting mode is a mode in which the image capturing apparatus 102 directly accepts an instruction from the photographer and carries out image capture processing, and there are cases where an image is shot using only the main camera 121 of the image capturing apparatus 102, and cases where images are shot using both the main camera 121 and the sub camera 122 of the image capturing apparatus 102. The remote shooting mode is a mode in which shooting is carried out upon receiving the shooting command from the terminal apparatus 101, and in this mode, an image is shot using only the main camera 121, and no images are shot using the sub camera 122. The reproduction mode is a mode in which the image capturing apparatus 102 reproduces a stored image and displays that image in the display unit 211 of the image capturing apparatus 102.

In step S309, the system control unit 202 displays the mode selection screen 400A, illustrated in FIG. 4A. Using this screen 400A, the photographer can select one of the normal shooting mode, the remote shooting mode, and the reproduction mode, and the image capturing apparatus 102 is set to the mode specified by the photographer as a result.

In step S310, the system control unit 202 determines whether the remote shooting mode is set. In the case where it is determined that the remote shooting mode is set, the processing moves to step S311, whereas in the case where it is determined that the remote shooting mode is not set, the processing moves to step S313.

In step S311, the system control unit 202 determines whether the instruction to start the remote shooting mode has been received from the terminal apparatus 101. In the case where it is determined that the instruction to start the remote shooting mode has been received, the processing moves to step S312, whereas in the case where it is determined that the instruction has not been received, the processing returns to step S311, where the system control unit 202 stands by until the instruction to start the remote shooting mode is received.

In step S312, the system control unit 202 carries out processing according to the remote shooting mode. Details of the remote shooting mode will be given later with reference to FIG. 5B.

In step S313, the system control unit 202 carries out processing aside from the remote shooting mode processing. If the mode that is set is the normal shooting mode, processing according to the normal shooting mode is carried out, whereas in the case where the mode that is set is the reproduction mode, processing according to the reproduction mode is carried out. In the processing according to the normal shooting mode, the system control unit 202 determines settings regarding whether or not to record the sub image data by referring to the system memory 206, and in the case where sub image data recording is set to “no”, executes the image capture processing using only the first image capturing unit 204, acquires the main image data, and records the main image data in the external storage medium such as a memory card, an HDD, or the like. On the other hand, in the case where sub image data recording is set to “yes”, the system control unit 202 executes the image capture processing using both the first image capturing unit 204 and the second image capturing unit 205, acquires the main image data and the sub image data, and records those pieces of data in association with each other in the external storage medium such as a memory card, an HDD, or the like. Note that detailed descriptions of the processing performed in the reproduction mode will be omitted here.

In step S314, the system control unit 202 determines whether a power cutoff event has occurred due to a power switch of the image capturing apparatus 102 being turned off. In the case where it is determined that the power cutoff event has occurred, the processing moves to step S315, whereas in the case where it is determined that the power cutoff event has not occurred, the processing returns to step S309.

In step S315, the system control unit 202 turns off the power of the image capturing apparatus 102 and ends the present processing.

GUI Screens

Next, screens displayed in the display unit 211 of the terminal apparatus 101 or the image capturing apparatus 102 will be described with reference to FIGS. 4A to 4D.

The display unit 211 of the terminal apparatus 101 includes a touch panel, and the photographer operates the terminal apparatus 101 by touching the touch panel. Screens 400A to 400D illustrated in FIGS. 4A to 4D, respectively, correspond to content displayed in the display unit 211 of the terminal apparatus 101.

FIG. 4A illustrates the mode selection screen 400A displayed in the display unit 211 of the terminal apparatus 101; this screen 400A is the first screen displayed in the display unit 211 of the terminal apparatus 101 when the shooting control app is launched. One of the normal shooting mode, the remote shooting mode, and the reproduction mode can be selected using the screen 400A illustrated in FIG. 4A.

The normal shooting mode is a mode in which only the terminal apparatus 101 shoots an image. The remote shooting mode is a mode in which the image capturing apparatus 102 is controlled by the terminal apparatus 101 and the image capturing apparatus 102 shoots an image. The reproduction mode is a mode in which an image shot in the normal shooting mode, the remote shooting mode, or the like is reproduced.

Buttons 401, 402, and 403 are selection buttons for setting the normal shooting mode, the remote shooting mode, and the reproduction mode, respectively. A button 404 corresponds to the end button for terminating the shooting control app.

The screens 400B, 400C and 400D displayed in the display unit 211 of the terminal apparatus 101 in the normal shooting mode, the remote shooting mode, and the reproduction mode will be described hereinafter.

FIG. 4B is a screen 400B displayed in the display unit 211 of the terminal apparatus 101 during the normal shooting mode.

The main image shot by the main camera of the terminal apparatus 101 is displayed in a display region 405.

When a button 406 is pressed, an image is shot and the image data is recorded in the terminal apparatus 101.

When a button 407 is pressed, the normal shooting mode is terminated and the screen 400B returns to the mode selection screen 400A illustrated in FIG. 4A.

FIG. 4C is a screen 400C displayed in the display unit 211 of the terminal apparatus 101 during the remote shooting mode.

The terminal apparatus 101 receives the main image obtained through the image capture processing performed by the first image capturing unit 204 of the image capturing apparatus 102 and displays that main image in the display region 405. As a result, the photographer can confirm a through-the-lens image, shot by the main camera 121 of the image capturing apparatus 102, in the display region 405. 408 indicates the sub image shot by the sub camera of the terminal apparatus 101, which is displayed in a reduced manner upon the main image of the display region 405.

When a button 409 is pressed, a remote shooting command is transmitted to the image capturing apparatus 102, and the main image shot by the main camera 121 of the image capturing apparatus 102 is recorded in the external storage medium, such as a memory card, an HDD, or the like, in the image capturing apparatus 102; at the same time, the sub image shot by the sub camera 112 of the terminal apparatus 101 is recorded in the external storage medium, such as a memory card, an HDD, or the like, in the terminal apparatus 101. The terminal apparatus 101 then receives the main image from the image capturing apparatus 102, and the sub image data shot by the terminal apparatus 101 and the main image data shot by the image capturing apparatus 102 are recorded into the non-volatile memory 207 or the external storage medium of the terminal apparatus 101 in association with each other. Here, based on the shooting dates and times of the main image and the sub image, the terminal apparatus 101 records the main image and the sub image whose shooting dates/times match as a single set. Alternatively, the main image, and a sub image having a shooting date and time within a predetermined range of time from the shooting date and time of the main image, are recorded as a set. Alternatively, the terminal apparatus 101 issues an identifier when the button 409 is pressed, the identifier is transmitted to the image capturing apparatus 102 along with the remote shooting command, and the sub image shot by the sub camera 112 of the terminal apparatus 101 is recorded in association with the identifier. Then, the image capturing apparatus 102 transmits the main image along with the identifier to the terminal apparatus 101, and the terminal apparatus 101 records the main image and the sub image as a set based on the identifier. In this manner, the main image and the sub image obtained through image capture processing executed in response to the same single shooting command can be managed as a set.

When a button 410 is pressed, the remote shooting mode is terminated and the screen 400C returns to the mode selection screen 400A illustrated in FIG. 4A.

FIG. 4D is a screen 400D displayed in the display unit 211 of the terminal apparatus 101 during the reproduction mode.

The reproduced image is displayed in the display region 405. 411 indicates the sub image shot by the sub camera 112 of the terminal apparatus 101 during the remote shooting mode; this image is displayed in a reduced manner on the main image of the display region 405 shot by the main camera 121 of the image capturing apparatus 102.

Buttons 412 and 413 are buttons for moving through images. A previous image is displayed when the button 412 is pressed, and a next image is displayed when the button 413 is pressed. When a button 414 is pressed, the reproduction mode is terminated and the screen 400D returns to the mode selection screen 400A illustrated in FIG. 4A.

Remote Shooting Mode Processing

Next, the processing performed in the remote shooting mode, indicated in step S306 of FIG. 3A and step S312 of FIG. 3B, will be described with reference to FIGS. 5A and 5B. Note that FIG. 5A indicates processing performed by the terminal apparatus 101, whereas FIG. 5B indicates processing performed by the image capturing apparatus 102.

First, the processing performed by the terminal apparatus 101 will be described with reference to FIG. 5A. The processing described hereinafter is executed by the system control unit 202 of the terminal apparatus 101.

In step S501, the system control unit 202 displays the remote shooting mode screen 400C, illustrated in FIG. 4C.

In step S502, the system control unit 202 starts a communication connection with the image capturing apparatus 102.

In step S503, the system control unit 202 receives main through-the-lens image data shot by the main camera of the image capturing apparatus 102. The “main through-the-lens image data” is image data resulting from the terminal apparatus 101 receiving the main image data obtained through the image capture processing performed by the first image capturing unit 204 of the image capturing apparatus 102 in real time and displaying that main image data in the display unit 211 of the terminal apparatus 101.

In step S504, the system control unit 202 displays the main through-the-lens image data received from the image capturing apparatus 102 and sub through-the-lens image data shot by the sub camera 112 of the terminal apparatus 101 in the display unit 211. The “sub through-the-lens image data” is image data resulting from the terminal apparatus 101 displaying the sub image data obtained through the image capture processing performed by the second image capturing unit 205 of the terminal apparatus 101 in real time in the display unit 211 of the terminal apparatus 101.

In step S505, the system control unit 202 determines whether the shoot button 409 has been pressed. In the case where it is determined that the shoot button 409 has been pressed, the processing moves to step S506, whereas in the case where it is determined that the shoot button 409 has not been pressed, the processing returns to step S503.

In step S506, the system control unit 202 transmits, to the image capturing apparatus 102, the shooting command for causing an image to be shot and recorded.

In step S507, the system control unit 202 records the sub image data shot by the sub camera of the terminal apparatus 101 into the external storage medium of the terminal apparatus 101 in response to the shooting command being transmitted in step S506. The shooting position information is acquired by the GPS unit 212 and the rotation information is acquired by the rotation sensor 214 during the shooting and recording, and the acquired shooting position information and rotation information are added to the sub image data and recorded along therewith.

In step S508, the system control unit 202 determines whether the main image data has been received from the image capturing apparatus 102. In the case where it is determined that the main image data has been received from the image capturing apparatus 102, the processing moves to step S509, whereas in the case where it is determined that the main image data has not been received, the processing returns to step S508, where the system control unit 202 stands by for the main image data to be received from the image capturing apparatus 102.

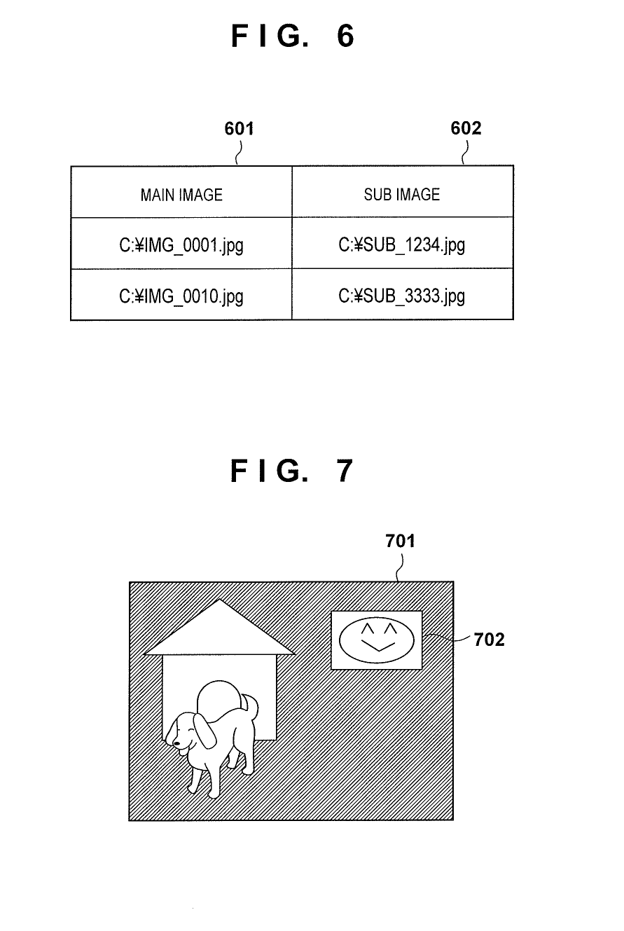

In step S509, the system control unit 202 records information for associating the main image data received from the image capturing apparatus 102 with the sub image data shot by the sub camera of the terminal apparatus 101. Details of the information for associating the image data will be given later with reference to FIG. 6.

In step S510, the system control unit 202 determines whether or not the return button 410 has been pressed; in the case where the return button 410 has been pressed, the processing moves to step S511, whereas in the case where the return button 410 has not been pressed, the processing returns to step S503.

In step S511, the system control unit 202 transmits, to the image capturing apparatus 102, a command to terminate the remote shooting mode.

In step S512, the system control unit 202 terminates the connection with the image capturing apparatus 102 and ends the present processing.

Next, the processing performed by the image capturing apparatus 102 will be described with reference to FIG. 5B.

In step S513, the system control unit 202 starts the communication connection with the terminal apparatus 101.

In step S514, the system control unit 202 determines whether the command to terminate the remote shooting mode has been received from the terminal apparatus 101. In the case where it is determined that the command to terminate the remote shooting mode has not been received, the processing moves to step S515, whereas in the case where it is determined that the command to terminate the remote shooting mode has been received, the processing moves to step S519.

In step S515, the system control unit 202 transmits the main image data obtained through the image capture processing performed by the first image capturing unit 204 in real time to the terminal apparatus 101 as the main through-the-lens image data.

In step S516, the system control unit 202 determines whether the shooting command has been received from the terminal apparatus 101; in the case where the shooting command has been received, the processing moves to step S517, whereas in the case where the shooting command has not been received, the processing returns to step S514.

In step S517, the system control unit 202 records the main image data shot by the main camera 121 of the image capturing apparatus 102 in the external storage medium of the image capturing apparatus 102. The shooting position information is acquired by the GPS unit 212 and the rotation information is acquired by the rotation sensor 214 during the shooting and recording, and the acquired shooting position information and rotation information are added to the main image data and recorded along therewith.

In step S518, the system control unit 202 transmits, to the terminal apparatus 101, the main image data shot by the main camera 121 of the image capturing apparatus 102 and recorded in the external storage medium, and the processing then returns to step S514.

In step S519, the system control unit 202 terminates the connection with the terminal apparatus 101 and ends the present processing.

Note that the terminal apparatus 101 may be capable of setting whether or not to shoot the sub image and the main image simultaneously. In this case, when the mode is set to the remote shooting mode while the terminal apparatus 101 is set to shoot the sub image and the main image simultaneously, the processing described earlier with reference to FIGS. 5A and 5B is executed, and the sub image shot by the sub camera 112 of the terminal apparatus 101 is recorded in the storage medium in association with the main image shot by the main camera 121 of the image capturing apparatus 102. On the other hand, when the mode is set to the remote shooting mode while the terminal apparatus 101 is set not to shoot the sub image and the main image simultaneously, the processes of S507, S509, and so on are skipped, and only the main image shot by the main camera 121 of the image capturing apparatus 102 is recorded in the storage medium. Alternatively, when in the remote shooting mode, the terminal apparatus 101 receives, from the image capturing apparatus 102, information regarding whether or not to record the sub image data, set in the image capturing apparatus 102; in the case where recording of the sub image data is set to “yes”, the processing described earlier with reference to FIGS. 5A and 5B is executed, and the sub image shot by the sub camera 112 of the terminal apparatus 101 is recorded in the storage medium in association with the main image shot by the main camera 121 of the image capturing apparatus 102. Here, in the case where the mode is set to the remote shooting mode, the system control unit 202 of the image capturing apparatus 102 carries out control so that shooting with the sub camera 122, or in other words, the image capture processing performed by the second image capturing unit 205, is not carried out, even if the recording of the sub image data is set to “yes”. On the other hand, if the recording of the sub image data is set to “no”, the processes of S507, S509, and the like are skipped, and only the main image shot by the main camera 121 of the image capturing apparatus 102 is recorded in the storage medium.

Next, a method for recording the main image data and the sub image data in association with each other will be described with reference to FIG. 6.

FIG. 6 illustrates a table for recording the main image data shot by the main camera 121 of the image capturing apparatus 102 and the sub image data shot by the sub camera 112 of the terminal apparatus 101 in association with each other as a management file in the remote shooting mode according to the present embodiment.

In FIG. 6, 601 indicates main image file paths. 602 indicates sub image file paths. The example shown in FIG. 6 indicates that a main image IMG_{—}0001.jpg and a sub image SUB_{—}1234.jpg were shot in a single instance of remote shooting. Likewise, a main image IMG_{—}0010.jpg and a sub image SUB_{—}3333.jpg were shot in a single instance of remote shooting.

Note that the main image and the sub image can be associated with each other using a method such as recording a filename of the sub image in the main image, instead of using the management file for associating the main image and the sub image with each other. Furthermore, when using the management file to associate the main image and the sub image with each other, unique IDs may be assigned to the image files rather than using filenames.

Furthermore, as shown in FIG. 7, the terminal apparatus 101 may generate a composite image in which a sub image 702 is superimposed on a main image 701 in a reduced state, and record that composite image as a single image file.

As described thus far, according to the present embodiment, the object side can be shot by the main camera 121 of the image capturing apparatus 102 and the photographer side can be shot by the sub camera of the terminal apparatus 101 simultaneously in the remote shooting mode. Accordingly, a state of the photographer can be shot and recorded when the image capturing apparatus 102 executes shooting and recording, even in the case where the photographer is away from the image capturing apparatus 102 and operates the terminal apparatus 101 in order to cause the image capturing apparatus 102 to shoot an image.

Although the present embodiment describes recording the main image shot by the image capturing apparatus 102 and the sub image shot by the terminal apparatus 101 in the storage medium of the terminal apparatus 101, it should be noted that the images may be recorded in the image capturing apparatus 102 or in an image management server located on a network. Specifically, in step S508, the terminal apparatus 101 transmits the sub image data recorded in step S507 to the image capturing apparatus 102 rather than receiving the main image data from the image capturing apparatus 102. The image capturing apparatus 102 then records the main image data recorded in step S517 and the sub image data received from the terminal apparatus 101 in association with each other in the storage medium of the image capturing apparatus 102. Here, regarding whether or not to record the sub image data, the image capturing apparatus 102 may receive the sub image data from the terminal apparatus 101 in the case where “yes” is set, and may cancel the reception of the sub image data from the terminal apparatus 101 in the case where “no” is set. In other words, the terminal apparatus 101 may transmit the sub image data to the image capturing apparatus 102 in the case where “yes” is set for the recording of the sub image data in the image capturing apparatus 102, and may cancel the transmission of the sub image data in the case where “no” is set. Alternatively, the terminal apparatus 101 may acquire the sub image data by executing the image capture processing performed by the second image capturing unit 205 in the case where “yes” is set for the recording of the sub image data in the image capturing apparatus 102, and may cancel the execution of the image capture processing in the case where “no” is set. Alternatively, the sub image data may be received from the terminal apparatus 101 regardless of whether or not the sub image data is set to be recorded; however, the sub image data may then be recorded into the storage medium in the case where “yes” is set, and may be deleted without being recorded into the storage medium in the case where “no” is set.

Alternatively, in step S508, the terminal apparatus 101 may transmit the sub image data recorded in step S507 to a server apparatus located on a network, rather than receiving the main image data from the image capturing apparatus 102. Likewise, in step S518, the image capturing apparatus 102 may then transmit the main image data recorded in step S517 to the server apparatus, rather than transmitting the main image data to the terminal apparatus 101. The server apparatus then records the sub image data received from the terminal apparatus 101 and the main image data received from the image capturing apparatus 102 in association with each other in a storage medium in the server apparatus.

Furthermore, the image capturing apparatus 102 need not include a sub camera. Further still, although the shot image is described as a still image, the shot image may be a moving image. In the case where a moving image is shot, audio data is also recorded by the microphone 213.

### Other Embodiments

Embodiment(s) of the present invention can also be realized by a computer of a system or apparatus that reads out and executes computer executable instructions (e.g., one or more programs) recorded on a storage medium (which may also be referred to more fully as a ‘non-transitory computer-readable storage medium’) to perform the functions of one or more of the above-described embodiment(s) and/or that includes one or more circuits (e.g., application specific integrated circuit (ASIC)) for performing the functions of one or more of the above-described embodiment(s), and by a method performed by the computer of the system or apparatus by, for example, reading out and executing the computer executable instructions from the storage medium to perform the functions of one or more of the above-described embodiment(s) and/or controlling the one or more circuits to perform the functions of one or more of the above-described embodiment(s). The computer may comprise one or more processors (e.g., central processing unit (CPU), micro processing unit (MPU)) and may include a network of separate computers or separate processors to read out and execute the computer executable instructions. The computer executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc (BD)™), a flash memory device, a memory card, and the like.

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Applications Nos. 2013-227534, filed Oct. 31, 2013 and 2014-210170, filed Oct. 14, 2014 which are hereby incorporated by reference herein in their entirety.

What is claimed is:

1. A system in which an image capturing apparatus is externally operated by a terminal apparatus to shoot an image,
wherein the terminal apparatus comprises:
an instructing unit configured to instruct the image capturing apparatus to start image capture processing;
a receiving unit configured to receive a first image acquired by the image capturing apparatus receiving the instruction and executing the image capture processing;
a sub capturing unit configured to acquire a second image by executing image capture processing for an object in response to an instruction from the instructing unit; and
a recording unit configured to record the first image and the second image in association with each other, and
wherein the image capturing apparatus comprises:
an acquiring unit configured to acquire the instruction for starting the image capture processing from the terminal apparatus;
a main capturing unit configured to acquire the first image by executing image capture processing for an object in response to the instruction; and
a transmitting unit configured to transmit the first image to the terminal apparatus.

2. A terminal apparatus comprising:
a communication unit configured to establish communication with an image capturing apparatus;
an instructing unit configured to instruct the image capturing apparatus to start image capture processing;
a receiving unit configured to receive a first image acquired by the image capturing apparatus receiving the instruction and executing the image capture processing;
a sub capturing unit configured to acquire a second image by executing image capture processing for an object in response to an instruction from the instructing unit; and
a recording unit configured to record the first image and the second image in association with each other.

3. An image capturing apparatus comprising:
a main capturing unit configured to acquire a first image by executing image capture processing for a first object;
a sub capturing unit configured to acquire a second image by executing image capture processing for a second object present in a different location than the first object;
an acquiring unit configured to acquire an instruction for starting the image capture processing from a terminal apparatus;
an accepting unit configured to directly accept an instruction to start the image capture processing in response to a photographer operating the image capturing apparatus; and
a capturing control unit configured to carry out control so as to stop the execution of the image capture processing by the sub capturing unit, execute the image capture processing by the main capturing unit, and acquire the first image when the instruction has been acquired by the acquiring unit, and carry out control so as to execute the image capture processing by the main capturing unit and the sub capturing unit and acquire the first image and the second image when the instruction has been accepted by the accepting unit.

4. A system in which an image capturing apparatus is externally operated by a terminal apparatus to shoot an image,
wherein the terminal apparatus comprises:
an instructing unit configured to instruct the image capturing apparatus to start image capture processing;
a sub capturing unit configured to acquire a second image by executing image capture processing for an object in response to an instruction from the instructing unit; and
a transmitting unit configured to transmit the second image to the image capturing apparatus, and
wherein the image capturing apparatus comprises:
an acquiring unit configured to acquire the instruction for starting the image capture processing from the terminal apparatus;
a main capturing unit configured to acquire a first image by executing image capture processing for an object in response to the instruction;
a receiving unit configured to receive the second image from the terminal apparatus; and
a recording unit configured to record the first image and the second image in association with each other.

5. A terminal apparatus comprising:
a communication unit configured to establish communication with an image capturing apparatus;
an instructing unit configured to instruct the image capturing apparatus to start image capture processing;
a sub capturing unit configured to acquire a second image by executing image capture processing for an object in response to an instruction from the instructing unit; and
a transmitting unit configured to transmit the second image to the image capturing apparatus,
wherein the second image is recorded in association with a first image acquired by the image capturing apparatus executing image capture processing for an object in response to the instruction.

6. An image capturing apparatus comprising:
a communication unit configured to establish communication with a terminal apparatus;
an accepting unit configured to accept an instruction for starting image capture processing from the terminal apparatus;
a main capturing unit configured to acquire a first image by executing the image capture processing for an object in response to the instruction;
a receiving unit configured to receive, from the terminal apparatus, a second image acquired by a sub capturing unit of the terminal apparatus executing image capture processing for an object in response to the instruction; and
a recording unit configured to record the first image and the second image in association with each other.

7. A system in which an image capturing apparatus is externally operated by a terminal apparatus to shoot an image,
wherein the terminal apparatus comprises:
an instructing unit configured to instruct the image capturing apparatus to start image capture processing;
a sub capturing unit configured to acquire a second image by executing image capture processing for an object in response to an instruction from the instructing unit; and
a first transmitting unit configured to transmit the second image to a server apparatus over a network,
wherein the image capturing apparatus comprises:
an acquiring unit configured to acquire the instruction for starting the image capture processing from the terminal apparatus;
a main capturing unit configured to acquire the first image by executing image capture processing for an object in response to the instruction; and
a second transmitting unit configured to transmit the first image to the server apparatus over a network, and
wherein the server apparatus comprises:
a recording unit configured to record the first image and the second image in association with each other.

8. A control method of a terminal apparatus which includes a capturing unit and externally operates an image capturing apparatus to shoot an image, the method comprising:
a step of establishing communication with the image capturing apparatus;
a step of instructing the image capturing apparatus to start image capture processing;
a step of receiving a first image acquired by the image capturing apparatus receiving the instruction and executing the image capture processing;
a step of acquiring a second image by executing the image capture processing for an object in response to the instruction; and
a step of recording the first image and the second image in association with each other.

9. The control method according to claim 8, further comprising:
a step of generating a composite image in which the first image and the second image are combined; and
a step of recording the composite image.

10. The control method according to claim 8, further comprising:
a step of determining whether or not the second image is necessary; and
a step of stopping the execution of the image capture processing for acquiring the second image in the case where the second image is determined to be unnecessary.

11. A control method of an image capturing apparatus, the method comprising:
a step of acquiring a first image by executing image capture processing for a first object;
a step of acquiring a second image by executing image capture processing for a second object present in a different location than the first object;
a step of acquiring an instruction for starting the image capture processing from a terminal apparatus;
a step of directly accepting an instruction to start the image capture processing in response to a photographer operating the image capturing apparatus; and
a step of carrying out control so as to stop the execution of the image capture processing for acquiring the second image, execute the image capture processing for acquiring the first image, and acquire the first image when the instruction has been acquired from the terminal apparatus, and carrying out control so as to execute the image capture processing for acquiring the first image and the image capture processing for acquiring the second image and acquire the first image and the second image when the instruction has been directly accepted.

12. The control method according to claim 11, further comprising:
a step of transmitting the first image to the terminal apparatus when the instruction has been acquired from the terminal apparatus.

13. The control method according to claim 11, further comprising:
a step of receiving, from the terminal apparatus, the second image acquired by the terminal apparatus executing image capture processing for an object in response to the terminal apparatus making the instruction, when the instruction has been acquired from the terminal apparatus; and
a step of recording the first image and the received second image in association with each other.

14. The control method according to claim 13, further comprising:
a step of determining whether or not the second image is necessary; and
a step of stopping the reception of the second image in the case where the second image is determined to be unnecessary.

15. The control method according to claim 13, further comprising:
a step of determining whether or not the second image is necessary; and
a step of stopping the recording of the received second image in the case where the second image is determined to be unnecessary.

16. A control method of a terminal apparatus, the method comprising:
a step of establishing communication with the image capturing apparatus;
a step of instructing the image capturing apparatus to start image capture processing;
a step of acquiring a second image by executing the image capture processing for an object in response to the instruction; and
a step of transmitting the second image to the image capturing apparatus,
wherein the second image is recorded in association with a first image acquired by the image capturing apparatus executing image capture processing for an object in response to the instruction.

17. The control method according to claim 16, further comprising:
a step of determining whether or not the second image is necessary; and
a step of stopping the execution of the image capture processing for acquiring the second image in the case where the second image is determined to be unnecessary.

18. The control method according to claim 16, further comprising:
a step of determining whether or not the second image is necessary; and
a step of stopping the transmission of the second image to the image capturing apparatus in the case where the second image is determined to be unnecessary.

19. A control method of an image capturing apparatus, the method comprising:
a step of establishing communication with a terminal apparatus;
a step of accepting an instruction for starting image capture processing from the terminal apparatus;
a step of acquiring a first image by executing the image capture processing for an object in response to the instruction;
a step of receiving, from the terminal apparatus, a second image acquired by the terminal apparatus executing image capture processing for an object in response to the instruction; and
a step of recording the first image and the second image in association with each other.

20. The control method according to claim 19, further comprising:
a step of determining whether or not the second image is necessary; and
a step of stopping the reception of the second image in the case where the second image is determined to be unnecessary.

21. The control method according to claim 19, further comprising:
a step of determining whether or not the second image is necessary; and
a step of stopping the recording of the second image in the case where the second image is determined to be unnecessary.

22. A non-transitory computer-readable storage medium storing a program for causing a computer to execute the control method according to claim 8.

23. A non-transitory computer-readable storage medium storing a program for causing a computer to execute the control method according to claim 11.

24. A non-transitory computer-readable storage medium storing a program for causing a computer to execute the control method according to claim 16.

25. A non-transitory computer-readable storage medium storing a program for causing a computer to execute the control method according to claim 19.
